(19) United States
(12) Patent Application Publication
(10) Pub. No.: US 2016/0365785 A1
(43) Pub. Date: Dec. 15, 2016

(54) Spiral spring and linear motor using same

(71) Applicants: Lubin Mao, Shenzhen (CN); Hongxing Wang, Shenzhen (CN)

(72) Inventors: Lubin Mao, Shenzhen (CN); Hongxing Wang, Shenzhen (CN)

(73) Assignee: AAC Technologies Pte. Ltd., Singapore city (SG)

(21) Appl. No.: 15/004,985

(22) Filed: Jan. 24, 2016

(30) Foreign Application Priority Data
Jun. 15, 2015 (CN) 201520412597.0

(51) Int. Cl. H02K 33/02; F16F 1/06

(52) U.S. Cl. CPC H02K 33/02; F16F 1/06

(57) ABSTRACT

A spiral spring includes a main body part winded by wire and two ends located on both ends of the main body part, wherein at least end of the ends of the spiral spring forms an end surface formed by wire encircling several circles, and the wire on the end surface forms a plane. A linear motor using the spiral spring is also disclosed.

### FIELD OF THE INVENTION

The present disclosure is related to linear motors, particularly to spiral springs of a linear motor.

### DESCRIPTION OF RELATED ART

The vibration motor is a part of utilizing the generation principle of electromagnetic force to transform electric energy into mechanical energy. Vibration motor generally is installed in a portable phone to generate silent receipt signal to prevent the inconvenience caused to other people due to external sounds. The vibration motor mainly can be divided into a rotating vibration motor and a linear vibration motor. When it is under the rotating vibration motor, rotor of weight imbalance rotates, therefore mechanical vibration is generated. In addition, under the linear vibration motor, the motor is vibrated by electromagnetic force and driven linearly, therefore mechanical vibration is generated.

China patent with publication patent number 102055297 discloses one kind of linear vibrator which includes a base, a coil element coupled to the base and forms the magnetic part of a closed magnetic circuit perpendicular to the current flowing through a coil unit. Magnet component moves relative to the coil element and supports the elastic part of the magnet component elastically. When a linearizer is at working condition, the magnet component vibrates linearly and horizontally. In the actual production, generally the elastic part is a spiral spring. One end of the spiral spring is welded or pasted on base. As the welded area of steel wire of the end is too small to ensure the welding strength, it causes the magnet component to deflect up or down when it vibrates linearly and horizontally.

Therefore, it is necessary to provide a new linear vibrator to overcome the problems mentioned above.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a linear motor of an embodiment of the present disclosure.

FIG. 2 is an isometric view of a spiral spring of the linear motor.

FIG. 3 is an isometric view of another spiral spring of the linear motor.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of present disclosure more apparent, the present disclosure is described in further detail together with the figures and the embodiments. It should be understood the specific embodiments described hereby is only to explain this disclosure, not intended to limit this disclosure.

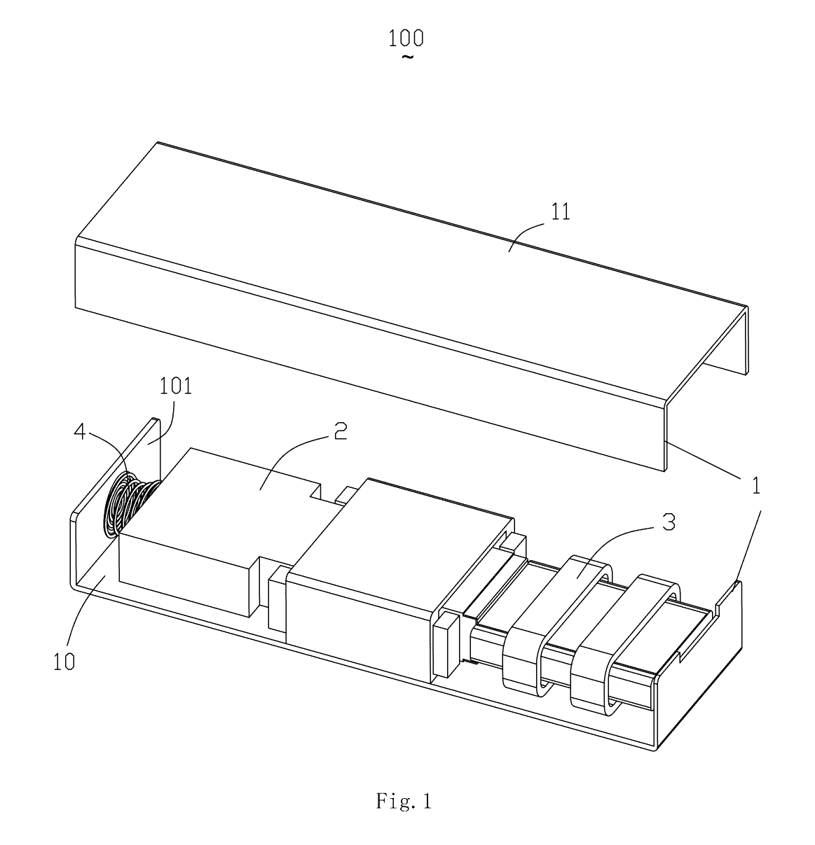

As shown in FIG. 1, a linear motor 100 includes a housing 1 set with a receiving space, a mass block 2 received in housing 1, a spiral spring 4 received in the housing 1 and a magnetic system 3. The magnetic system 3 is located on one end of the mass block 2. The spiral spring 4 is located on the other end of the mass block 2. The mass block 2 and the magnetic system 3 are defined as a vibrator (not marked). The vibrator can also contain other components relative to the motion of the housing.

The housing 1 includes a lower cover 10 supporting the mass block 2 and the magnetic system 3 and a upper cover closing with the lower cover 10. The lower cover 10 includes a side wall 101 perpendicular to the vibration direction of the linear motor 100. One end of the spiral spring 4 is welded or pasted on the side wall 101. The other end is abutted against the mass block 2 to provide restoring force to the moving vibrator.

The wire of end surface 41 covers the end face 42 or the end surface 42 covered with wire is assigned at any shapes. When the spiral spring 4 is welded or pasted on the housing 1 of the linear motor. Welded or pasted area is large. The stability of welding or pasting is high. In order to abut the spiral spring 4 into larger area of the mass block 2, the other end 41 can be set into end surface 42 of wire winded from center to outside to guarantee that the spiral spring 4 is abutted against the mass block 2 and restoring force applied to the vibrator is balanced.

The spiral spring 4 includes a main body part 40 winded by wire and the end 41 located on both ends of the main body part 40. The end 41 of at least one end of the spiral spring 4 forms the end face of wire 42 winded from center. The wire of end face 42 is covered on end face 42 spirally or the end face 42

The spiral spring 4 is winded by one wire. Generally, steel material is adopted for the wire. Its main body part is cylindrical. In order to guarantee contact force, wire must be winded three circles on the end face.

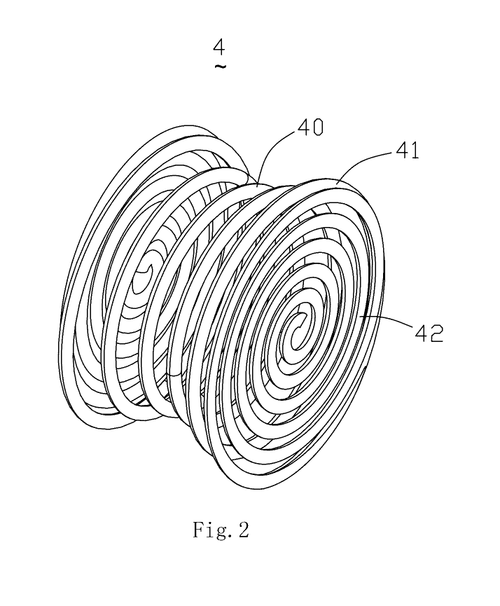

Of course, shown as in FIG. 2, the main body part 40 can be set the middle to be projected and drum-shaped. At the moment, the wire of two end faces 42 is winded from center to outside. When the spiral spring 4 is compressed, the trip distance is maximum.

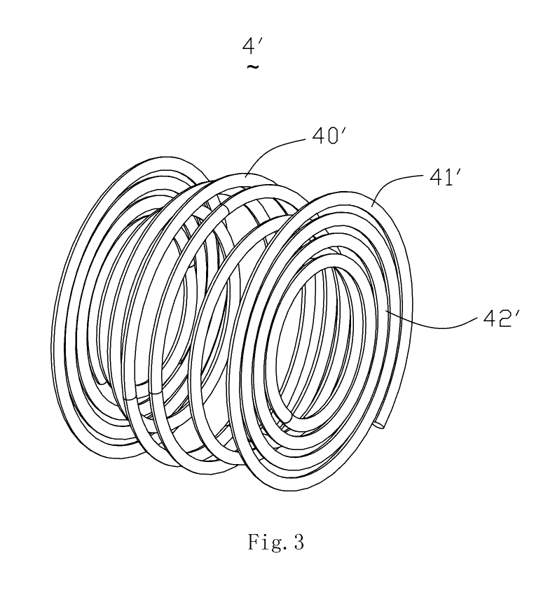

As shown in FIG. 3, a middle recess with perboloid of one sheet shape can be set in main body part 40′. At the moment, the wire of end faces 42′ of two ends 41′ is winded from outside to the center. When the spiral spring 4′ is compressed, the trip distance is maximum.

The end surface 42 encircling wire from center to outside or from outside to center is formed on the end 41 of the spiral spring 4. Preferably, it makes wire to cover the whole end surface 42. When the spiral spring 4 is welded or pasted on the housing of the linear motor of utility model, the welded or pasted area is large and the stability of welding or pasting is high, it guarantees when the vibrator vibrates linearly and horizontally, it does not deflect up or down. Besides, the spiral spring 4 of utility model is winded by one steel wire. It is simple to manufacture and the cost is low.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A spiral spring, including a main body part winded by wire and two ends located on both ends of the main body part, wherein at least end of the ends of the spiral spring forms an end surface formed by wire encircling several circles, and the wire on the end surface forms a plane.

2. The spiral spring as described in claim 1, wherein the wire on the end surface is winded from center to outside or from outside to the center.

3. The spiral spring as described in claim 1, wherein the wire covers entirely the end surface.

4. The spiral spring as described in claim 1, wherein the main body part and ends are winded by one wire.

5. The spiral spring as described in claim 1, wherein the main body part is cylindrical.

6. The spiral spring as described in claim 1, wherein the main body part is drum-shaped.

7. A linear motor, comprising the spiral spring described in claim 1, wherein the linear motor further includes a vibrator and a housing that receives the spiral spring and the vibrator, the spiral spring has an end abutting against the vibrator.
